(19) United States
(12) Patent Application Publication
(10) Pub. No.: US 2002/0163692 A1
(43) Pub. Date: Nov. 7, 2002

(54) Method and apparatus for adding wavelength components to and dropping wavelength components from a dense wavelength division multiplexed optical signal

(76) Inventor: Alexander B. Romanovsky, San Jose, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/138,009

(22) Filed: May 2, 2002

Related U.S. Application Data
(60) Provisional application No. 60/288,693, filed on May 4, 2001.
(60) Provisional application No. 60/288,685, filed on May 4, 2001.

(51) Int. Cl. H04J 14/02

(52) U.S. Cl. 359/127; 359/128

(57) ABSTRACT

An add/drop apparatus uses a series of switches and at least one Bragg grating. Each switch operates in a first state and a second state. A signal traveling in a first direction passes through each switch from a respective first port to a respective second port without reflection, whether the switch is in the first or in the second state. After passing through the series of switches, the signal interacts with a Bragg grating. The Bragg grating reflects a component of the signal at at least one specific wavelength back in a second direction opposite the first direction. The component of the signal traveling in the second direction propagates from the respective second port to the respective first port, without reflection, in each switch operating in the first state. The component of the signal traveling in the second direction is reflected from the second port to a third port by a switch operating in the second state. By selecting which switch is operating in the second state, the signal can be routed to a selected location coupled to the third port of the switch operating in the second state.

### PRIORITY APPLICATION

This application claims priority under 35 U.S.C. §119(e) from U.S. Provisional Patent Application No. 60/288,693, filed May 4, 2001 and entitled “Programmable Optical Add-drop Multiplexer” and from U.S. Provisional Patent Application No. 60/288,685, filed May 4, 2001 entitled “Method and Apparatus for Adding Wavelength Components to and Dropping Wavelength Components from a Dense Wavelength Division Multiplexed Optical Signal”.

### BACKGROUND OF THE INVENTION

1. Field of the Invention

The present invention relates to the field of systems for selectively adding and dropping wavelength components of a dense wavelength division multiplexed (DWDM) optical signal.

2. Description of the Related Art

A DWDM optical signal comprises a large number of discrete optical signals propagating together at different wavelengths, e.g., in a waveguide. In order to receive a particular signal at a particular wavelength, it is necessary to separate (i.e., drop) the discrete optical signal from the DWDM optical signal. In order to transmit a particular optical signal within the DMDW optical signal, it is necessary to add the discrete optical signal to the DWDM signal. An exemplary add/drop apparatus uses separate demultiplexers to separate all the discrete wavelength components of a DWDM optical signal, uses switch matrices to add and drop particular components at particular wavelengths, and uses separate multiplexers to recombine the desired components of the signal to recreate the DWDM signal. This results in a complex structure of multiplexers and switch matrices.

### SUMMARY OF THE INVENTION

An add/drop apparatus is needed that is a simpler, easier to manufacture and less expensive. Unlike conventional add/drop apparatus, the add/drop apparatus in accordance with the present invention eliminates the de-multiplexing step and apparatus by using a system comprising optical switches and optical filters for selectively dropping signals at particular wavelengths from a multiplexed beam. Additionally, the optical switches may be used to add signals at particular wavelengths to a DWDM signal.

One aspect of the present invention is an apparatus for selectively outputting at least one optical signal at a selected wavelength from a plurality of optical signals at a plurality of wavelengths. The apparatus comprises an optical propagation path in which optical signals propagate in a first direction and a second direction. At least one wavelength selective reflector is positioned at a location in the optical propagation path and is tuned to at least one optical wavelength. At least one optical switch has a first port, a second port and a third port. The optical switch selectively operates in one of a first state and a second state. The optical switch passes optical signals propagating in the first direction from the first port to the second port when the optical switch is operating in either the first state or the second state. The optical switch passes at least one optical signal propagating in the second direction from the second port to the first port when the optical switch is operating in the first state. The optical switch reflects at least one optical signal propagating in the second direction from the second port to the third port when the optical switch is operating in the second state. An output propagation path is coupled to the third port of the optical switch to receive the at least one optical signal when the optical switch is operating in the second state.

Another aspect of the present invention is an apparatus for selectively outputting at least one optical signal at a selected wavelength wherein the optical signal propagates with a plurality of optical signals at a plurality of wavelengths. The apparatus comprises an optical path for propagating the plurality of optical signals. The optical path has a first propagation direction and a second propagation direction. At least one optical switch is positioned at a first location in the optical path. The optical switch is switchable between a first state and a second state. The optical switch operates in the first state to propagate optical signals propagating in the first direction and optical signals propagating in the second direction without reflection. The optical switch operates in the second state to propagate optical signals propagating in the first direction without reflection and to reflect optical signals propagating in the second direction. At least one wavelength selective reflector is positioned at a second location in the optical path. The second location is disposed in the first direction from the first location. The wavelength selective reflector operates to reflect an optical signal at a selected wavelength propagating in the first direction from the optical switch to cause the optical signal at the selected wavelength to propagate in the second direction toward the optical switch. The reflected optical signal is reflected by the optical switch when the optical switch is operating in the second state. An output port is coupled to the optical switch to receive the optical signal reflected by the optical switch, thereby separating the optical signal at the selected wavelength from the plurality of optical signals.

Another aspect of the present invention is a method of selectively separating a wavelength component from a wavelength division multiplexed optical signal. The method receives a wavelength division multiplexed optical signal and propagates the wavelength division multiplexed signal through at least one switch in a first direction toward a wavelength selective reflector. The method reflects a component of the wavelength division multiplexed signal at a selected wavelength from the reflector in a second direction toward the switch. The method also reflects the component of the wavelength division multiplexed signal to a port of the switch.

### BRIEF DESCRIPTION OF THE DRAWINGS

The preferred embodiment of the present invention will be described below in connection with the attached drawings in which:

FIG. 1 is a top view of an optical switch used in one preferred embodiment;

FIG. 2A is a perspective view of the optical switch shown in FIG. 1;

FIG. 2B is a perspective view of one embodiment of an optical switch configured to reduce fringe fields;

FIG. 3 is a top view of the optical switch depicting an optical signal propagating through the optical switch in a first direction from a first port to a second port when the switch is in either the off state or the on state;

FIG. 4 is a top view of the optical switch depicting the optical signal propagating through the optical switch in a second direction from the second port to the first port when the optical switch is in the off state;

FIG. 5 is a top view depicting the optical signal propagating through the optical switch in the second direction from the second port to a third port when the switch is in the on state such that the optical signal is reflected at the TIR boundary;

FIG. 6 is a top view of one embodiment of an add/drop apparatus comprising a plurality of optical switches and an optical filter;

FIG. 7 depicts an optical beam passing through the apparatus of FIG. 6, where one switch is activated such that one wavelength is dropped from the DWDM composite signal;

FIG. 8 depicts an optical beam passing through the apparatus of FIG. 6, where one switch is activated such that one wavelength is added to the DWDM composite signal;

FIG. 9 is a top view of a second embodiment of an add/drop apparatus in which a first set of optical switches is connected to a plurality of input/output ports and a second set of optical switches is connected to a plurality of optical filters;

FIG. 10 depicts the operation of the apparatus shown in FIG. 9, wherein one wavelength is dropped; and

FIG. 11 depicts the operation of the apparatus shown in FIG. 9, wherein one wavelength is added.

### DETAILED DESCRIPTION OF THE PREFERRED EMBODIMENT

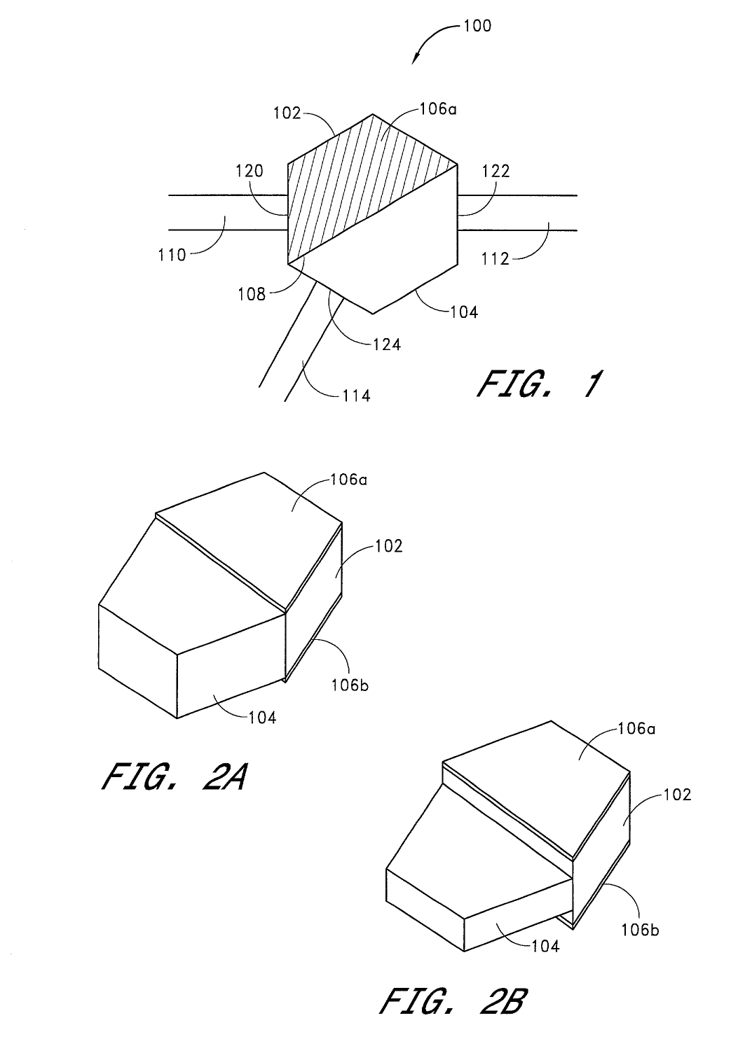

FIGS. 1, 2A, and 2B schematically illustrate a preferred embodiment of an optical switch 100. The optical switch 100 generally comprises a first portion 102 and a second portion 104. A pair of electrodes 106a, 106b are preferably disposed on opposite sides (e.g., the top and the bottom) of the first portion 102. A boundary 108 separates the two portions 102, 104. As discussed below, the characteristics of the boundary 108 are determined by the refractive indices of the two portions 102, 104.

The first portion 102 comprises an electro-optic material having an index of refraction that varies in response to application of an electric field. The second portion 104 comprises an electro-optic material that is not subject to the electric field. Alternatively, the second portion 104 may comprise a material that has an index of refraction that is insensitive to electric fields. In one preferred embodiment, the refractive index of the first portion 102 matches that of the second portion 104 in the absence of an electric field so as to permit an incident light beam Iᵢ to propagate through the boundary 108 without substantial Fresnel reflection. However, when the switch 100 is exposed to an electric field, the refractive index of the first portion 102 is substantially changed. The refractive index of the second portion 104 remains substantially unchanged by the electric field. As such, the resulting difference in refractive indices between the two portions 102, 104 creates a refractive index interface at the boundary 108. The difference in the refractive indices of the two portions is sufficient to cause total internal reflection (TIR) of the light beam Iᵢ incident on the boundary 108 at an angle greater that a critical angle.

Light paths 110, 112, and 114 are preferably coupled to the optical switch 100, as shown in FIG. 1. The first light path 110 is coupled to the first portion 102 at a first port 120. The second light path 112 is coupled to the second portion 104 at a second port 122. The third light path 114 is coupled to the second portion 104 at a third port 124. The light paths 110, 112, and 114 preferably comprise waveguides. The waveguides preferably comprise a material with the same or a similar index of refraction as the optical switch 100, for example, when the switch is in at least one state. The light paths 110, 112, and 114 may comprise other types of light propagating devices as known in the art and may be an optical transmissive region that supports free space or unguided lightwave propagation. The first portion 102 and the second portion 104 are shaped such that the switch 100 has a hexagonal shape. The shape of the optical switch, however, need not be so limited and may be in the shape of a square, rectangle, or parallelogram. Alternatively, the optical switch 100 may include curved surfaces, for example, spherical or elliptical shaped surfaces or structures having other curved forms. However, a hexagonal shaped optical switch 100 advantageously reduces the size of the optical switch 100.

Each of the light paths 110, 112, and 114 is incident substantially perpendicular to one of the sides of the switch 100 so that substantially no refraction occurs at the respective port 120, 122 or 124 at the boundary of a path and a side of the switch 100. Also, less reflection is encountered for light normally incident on a refractive index interface. Furthermore, the interface between the light paths 110, 112 and 114 and the sides of the switch 100 are preferably equipped with anti-reflective coatings for further reducing and/or altogether preventing reflection. Additionally, the light paths 110, 112, 114 are preferably directed at a sufficient angle with respect to one another to prevent or reduce crosstalk among the respective light paths 110, 112 and 114. Because of the shape of the switch 100, light entering the switch 100 from a path 110, 112, 114 is incident on the boundary 108 at an angle greater than the critical angle. The critical angle is measured with respect to the line normal to the boundary 108 and is determined by the change in index of refraction created by the electric field at the boundary 108.

As discussed herein, the boundary 108 is a surface located between the two portions 102, 104 at all times. This boundary may be compositional or may be a function of the placement of the electrodes 106a and 106b. When the two refractive indices in portions 102 and 104 are the same, the boundary 108 is neither reflective or refractive and has no significant effect on the light passing through the boundary 108. When the refractive indices in portions 102 and 104 are different, the boundary 108 has the effects discussed below.

The refractive index interface is generated by applying a voltage between the electrodes 106a, 106b. As shown in FIG. 2A, the electrodes 106a, 106b are preferably identically shaped to cover only the first portion 102 and are disposed on opposite sides of the first portion 102 so as to generate an electric field that is parallel to the boundary 108. Although in the preferred embodiment, the electrodes 106a, 106b are only on the first portion 102, in an alternative embodiment in which the second portion 104 is insensitive to the electric field, the electrodes could be on both the first portion 102 and the second portion 104. In this case, the switch 100 will still operate in the manner as set forth above since the second portion 104 is substantially insensitive to the electric field. In a particularly preferred embodiment, the second portion 104 is not exposed to the electric field and the electrodes 106a, 106b are proximate only to the first portion 102. In such an embodiment, the second portion 104 has material removed from a top step and a bottom step, as shown in FIG. 2B, to prevent and limit the electric field from fringing into the second portion 104 from the first portion 102, in order to have minimal effect on the boundary 108.

In a preferred embodiment, at least the first portion 102 of the switch 100 comprises an electro-optically active lead lanthanum zirconate titanate (PLZT) material. The second portion 104 preferably comprises a PLZT material in which the electro-optic response is deactivated by further processing. Since both portions 102, 104 are formed from PLZT, both portions 102, 104 have substantially similar refractive indices when the electric field is not applied to the first portion 102. The materials differ principally in that one is responsive to application of an electric field, while the other is substantially less responsive or non-responsive to the electric field. For example, application of an electric field to electro-optically active PLZT reduces the refractive index of this material for light polarized parallel to the applied electric field. Deactivated PLZT does not exhibit this same effect.

In one embodiment, for example, the deactivated PLZT material comprises a plurality of chemicals, which, in combination, are sufficient to enable formation of electro-optically inactive PLZT. Preferably, the chemicals combine to form a transmissive material having suppressed electro-optical properties. Further details regarding deactivated electo-optic material are discussed in U.S. patent application Ser. No. 09/891,689, entitled “Deactivated Electro-Optic Material and Method of Forming the Same” filed Jun. 26, 2001, now U.S. Pat. No. ______, which is incorporated herein in its entirety.

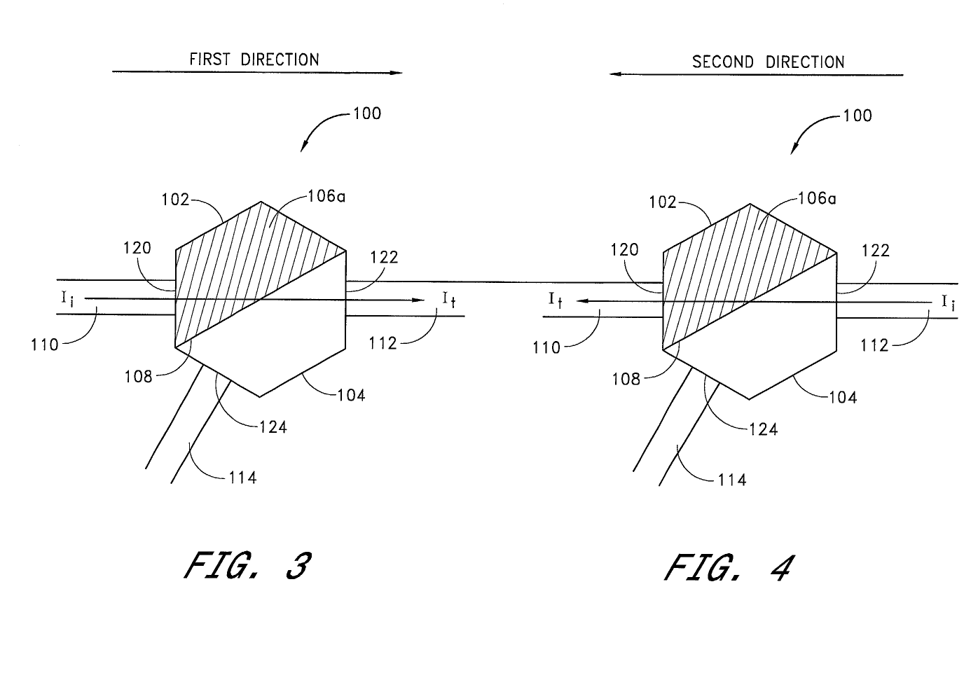

The optical switch 100 functions to transmit an incident light signal Iᵢ without reflection when the signal travels in a first direction and to selectively transmit or reflect an incident light signal Iᵢ when the signal travels in a second direction. An example of an incident light signal Iᵢ transmitted through the optical switch 100 in the first direction is shown in FIG. 3. The light signal propagates through the first light path 110 and into the first portion 102 at the first port 120. Advantageously, the materials comprising the light paths 110, 112, 114, the first portion 102 and the second portion 104 have substantially the same refractive index so that the light beam Iᵢ can travel through the ports 120, 122, 124 with reduced reflection and minimal refraction. As further shown, the light paths 110, 112 and 114 are perpendicular to the respective ports 120, 122, 124 to minimize any reflection or refraction of the light in paths 110, 112, 114 at the ports 120, 122, 124.

The light signal then propagates through the first portion 102 and into the second portion 104 at the boundary 108, whether or not the optical switch 100 is in an on state or an off state. The first portion 102 has a lower index of refraction than the second portion 104 while the optical switch 100 is in the on state. No total internal reflection (TIR) will result for the light passing from the region of lower refractive index (first portion 102) into a region of higher refractive index (second portion 104). Preferably, the two portions 102, 104 have similar or same indices of refraction when the optical switch 100 is in the off state. Thus, the light signal passes from the first portion 102 through the boundary 108 to the second portion 104 without experiencing substantial reflection in either state. The light signal then propagates through the second portion 104 and into the second light path 112 at the second port 122.

FIG. 4 illustrates the bi-directional characteristics of an optical switch 100 in the off state by showing an incident light signal Iᵢ transmitted through the optical switch 100 in a second direction. When it is desirable to have the light signal propagate from the second light path 112 to the first light path 110, no electric field is applied between the electrodes 106a and 106b. The refractive indices of the first portion 102 and the second portion 104 are preferably the same or substantially the same in the absence of the electric field, thus permitting the incident light beam Iᵢ to pass through the boundary 108 without experiencing reflection. Advantageously, the materials comprising the first portion 102 and second portion 104 preferably have substantially the same refractive index in the absence of the electric field so that the incident light beam Iᵢ can travel through the boundary 108 with no Fresnel reflection and little, if any, refraction, and thus reaches the first light path 112 with substantially no signal loss at the boundary 108.

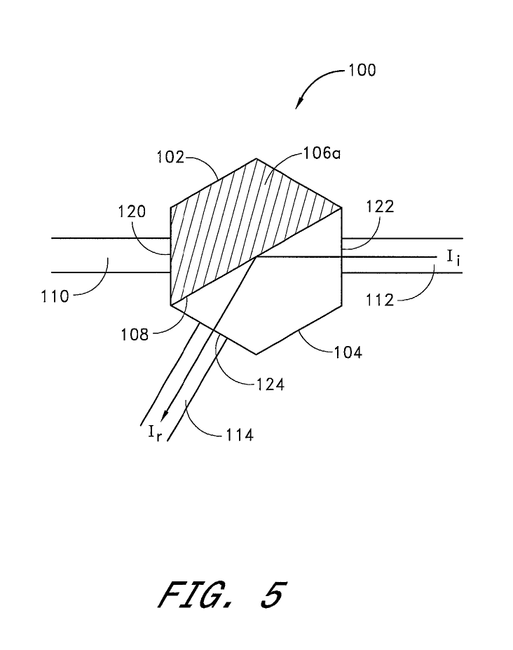

FIG. 5 illustrates the bi-directional characteristics of the optical switch 100 in the on state. When it is desirable to have a light signal switch from the second light path 112 to the third light path 114, an electric field is applied between the electrodes 106a and 106b (shown in FIGS. 2A and 2B). The application of the electric field between the electrodes 106a and 106b lowers the refractive index of the first portion 102 so that the incident light beam Iᵢ that enters the second portion 104 from the second light path 112 at the second port 122 and strikes the boundary 108 is total internally reflected. Thus, the light signal is reflected at the boundary 108, remains in the second portion 104, and enters the third light path 114 at the third port 124 as a reflected signal Iᵣ.

This optical switch is described in U.S. Pat. No. 6,310,712, “Discrete Element Light Modulating Microstructure Devices” issued to Romanovsky on Oct. 30, 2001, U.S. Pat. No. 6,381,060, “Total Internal Reflection Light Modulating Microstructure Devices” issued to Romanovsky on Apr. 30, 2002, as well as U.S. patent application Ser. No. 10/013336, entitled “Electo-Optic Switching Assembly and Method” filed Nov. 5, 2001, now U.S. Pat. No. ______, in which are hereby incorporated by reference in their entirety.

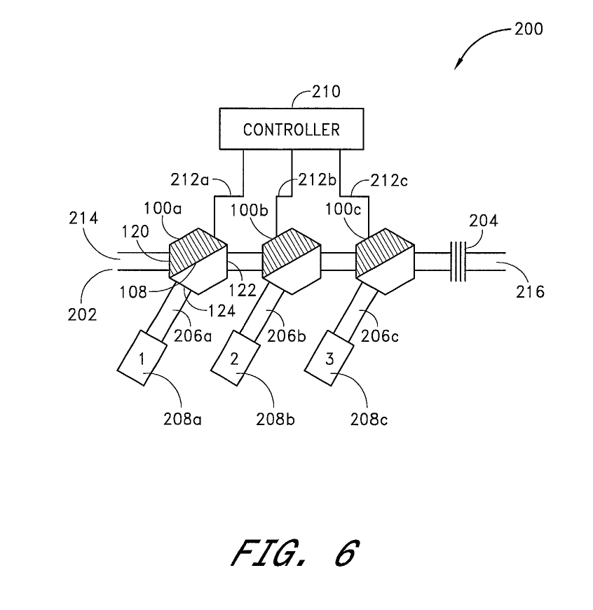

FIG. 6 illustrates a first embodiment of an add/drop apparatus 200. The first embodiment 200 preferably comprises a plurality of optical switches 100a, 100b, 100c positioned along an optical propagation path 202. Each optical switch 100a, 100b, 100c is preferably oriented such that a light signal traveling in the direction from an input end 214 of the optical propagation path 202 toward an output end 216 of the optical propagation path 202 enters each optical switch 100a, 100b, 100c through the respective first optical switch port 120 and exits the optical switch 100a, 100b, 100c through the respective second optical switch port 122. An optical filter 204 is positioned along the optical propagation path 202 between the last optical switch 100c and the output end 216.

The optical filter 204 preferably comprises a structure that selectively reflects a wavelength component of a DWDM signal passing through the optical filter 204. The preferred optical filter 204 is a Bragg filter. Other optical filter devices may also be used, and the design of the apparatus 200 should not be limited to any particular one. For example, gratings, both waveguide gratings and fiber gratings, may be suitably employed, fiber optic Bragg gratings and planar waveguide-based Bragg gratings being preferred. Alternate wavelength selective filters, such as dielectric filters, may also be used.

Additionally, a respective input/output port 208a, 208b, 208c is preferably coupled to each optical switch 100a, 100b, 100c by a respective input/output path 206a, 206b, 206c. The input/output paths 206a, 206b, 206c are preferably coupled to the optical switches 100a, 100b, 100c at the respective third ports 124. The input/output ports 208a, 208b, 208c may function as a destination for or a source of an optical signal and may comprise, for example, a detector, a laser, or an optical fiber or waveguide that is coupled to another optical system.

A controller 210 is electronically coupled to each optical switch 100a, 100b, 100c by signal lines 212a, 212b, 212c. Each signal line 212a, 212b, 212c is coupled to the respective optical switch electrodes 106a, 106b of the optical switches 100a, 100b, 100c for selectively applying a voltage across the optical switches 100a, 100b, 100c. It should be understood that two connections are coupled to each pair of electrodes 106a, 106b; however, for ease of understanding, only one signal line 212a, 212b, 212c is shown for each pair. In preferred embodiments, the second electrode 106b of each pair are connected in common and may advantageously be connected to a common signal return.

Similar to the light paths 110, 112, 114 described above, the optical propagation path 202 and the input/output paths 206a, 206b, 206c preferably comprise waveguides. For example, the optical propagation path 202 and the input/output paths 206a, 206b, 206c may comprise optical fibers or planar waveguides integrated on a substrate or other light propagating material known by those skilled in the art. Alternatively, the path may comprise free space regions where light is substantially unguided. These free space regions may be regions where light propagates through air, vacuum or an optically transmissive material in an unguided fashion. These free space regions are configured not to guide light like a waveguide but instead to support free space light propagation.

The above-described add/drop apparatus is merely one architecture of the first embodiment 200. For example, additional optical switches 100 coupled with input/output ports 208 may be inserted along the optical propagation path 202. Furthermore, a plurality of such add/drop apparatuses 200 can be cascaded to drop a plurality of wavelengths from an optical signal.

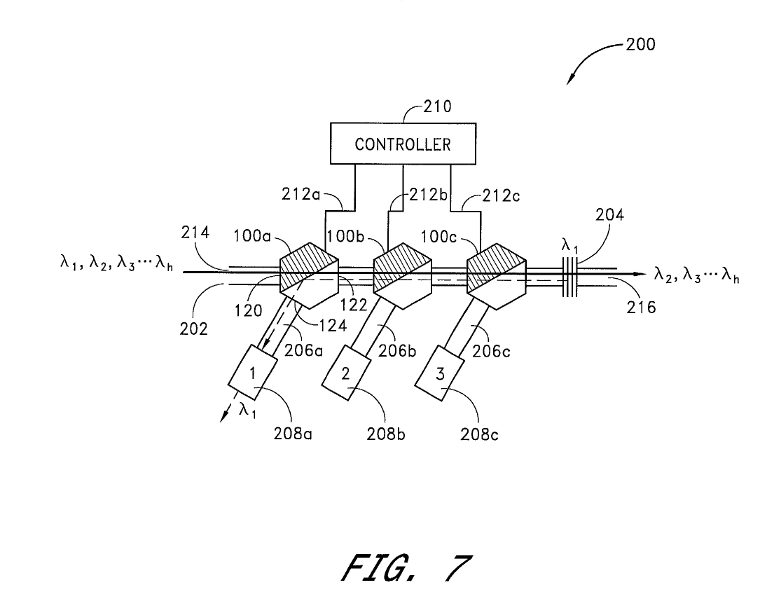

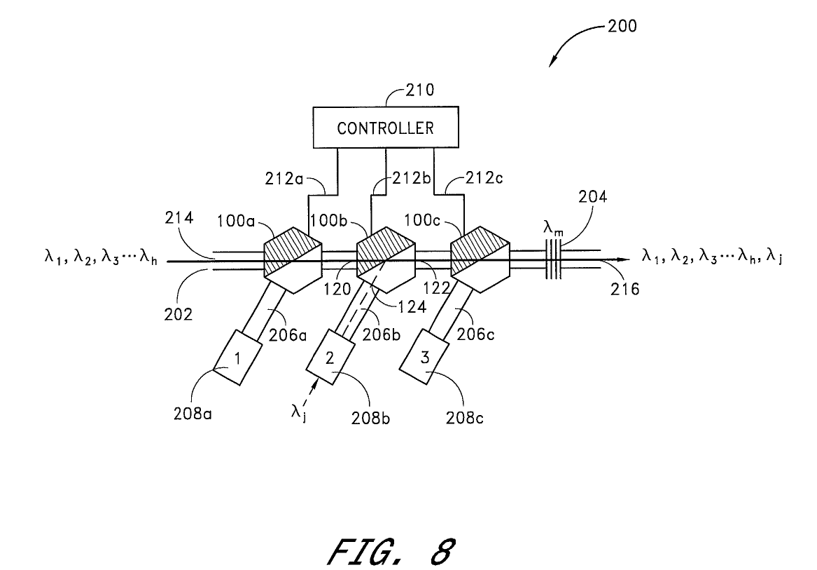

By way of example, the drop function of the first embodiment of FIG. 6 is shown in FIG. 7. A DWDM signal (illustrated as a bold line) is applied at an input end 214 of the optical propagation path 202. The DWDM signal may have many signal components at slightly different wavelengths. For example, the DWDM signal may advantageously have up to 32, 64, or 128 or more different wavelength components. In FIG. 7, the DWDM signal at the input end 214 of the optical propagation path 202 comprises the wavelengths λ1, λ2, λ3 . . . λh.

From the input end 214, the DWDM signal propagates along the optical propagation path 202 in a direction toward the output end 216. The DWDM signal first passes through the first port 120 of the first optical switch 100a and into the respective first portion 102. The DWDM signal then crosses the boundary 108 into the second portion 104 and out of the optical switch 100a at the second port 122. As described above, the DWDM signal traveling from the first portion 102 to the second portion 104 does not experience TIR, whether or not the switch is in the on state.

The DWDM signal then propagates down the optical propagation path 202 through the rest of the series of switches 100b, 100c in a similar manner until the DWDM signal arrives at the optical filter 204, wherein a single wavelength (e.g., λ1) is reflected. The optical filter 204 allows all wavelength components of the incoming DWDM signal to pass through in a forward direction, except for the selected signal component at the wavelength λ1. The selected component at the wavelength λ1 is referred to herein as “the component λ1.” The optical filter 204 is preferably configured during its manufacture to select one particular wavelength component to drop from the incoming DWDM signal.

The optical filter reflects the component λ1 to cause the component λ1 to propagate in a substantially opposite direction as the incoming DWDM signal. In FIG. 7, the dashed line represents the path of the selected component λ1. Note that the path of the selected component λ1 may lie directly over the path of the DWDM signal. However, for purposes of illustration and explanation, the path of the component λ1 is shown separately from the DWDM signal.

The controller 210 selects an optical switch 100 to be in either the on state or the off state. The controller 210 selects only one optical switch (e.g., the optical switch 100a in FIG. 7) to be in the on state and selects all other optical switches (e.g., the optical switches 100b and 100c) to be in the off state. The controller 210 selects the optical switch 100 to be in the on state depending upon which input/output port 208a, 208b or 208c is to receive the selected component λ1.

By way of example, the controller 210 in FIG. 7 selects the first optical switch 100a to be in the on state. Thus, the selected component λ1 passes through the third optical switch 100c and passes through the second optical switch 100b without reflection. The selected component λ1 then enters the first optical switch 100a, wherein the selected component λ1 is reflected toward the input/output port 208a. Thus, the add/drop apparatus 200 has the advantage that a component of a DWDM signal may be separated from the DWDM signal without de-multiplexing the DWDM signal.

The add/drop apparatus 200 may also use a particular input/output port 208a, 208b, 208c for adding a wavelength component to the DWDM signal. By way of example, FIG. 8 shows a component at a wavelength λj (hereinafter “component λj”) added to a DWDM signal. Here, a DWDM comprising the wavelengths λ1, λ2, λ3 . . . λh is applied at the input end 214, and the component λj is applied through the second input/output port 208b of the present add/drop apparatus 200. The path of the DWDM signal propagating through the add/drop apparatus 200 is shown as a bold line. The path of the component λj propagating through the add/drop apparatus 200 is shown as a dotted line.

The component λj exits the third input/output port 208b and propagates through input/output path 206b and enters the second optical switch 100b. In order to add the component λj to the DWDM signal, the controller 210 of the add/drop apparatus 200 selects the second optical switch 100b to be in the on state. Consequently, the component λj enters the second optical switch 100b at the third port 124 and is reflected at the respective boundary 108 in the direction of the second port 122. At this point, the component λj is added to the DWDM signal, which is also propagating through the second optical switch 100b.

The DWDM signal, which includes the added component λj, then propagates along the optical propagation path 202 and through all remaining optical switches (e.g., the third optical switch 100c) along the optical propagation path 202 to the output end 216. The DWDM signal then passes through the optical filter 204, preferably without reflection. By way of example, FIG. 8 shows that the optical filter 204 only reflects the wavelength λm. Note that if λm is an input signal, it will be reflected at the filter 204. The λm component would then propagate through optical switch 100c and into optical switch 100b. Because optical switch 100b is in the on state, λm will be reflected to the port 208b. Of course, if λm is not in the signal, the filter 204 will have no effect. In particular, it is preferred that the optical filter 204 is not selected to reflect the added wavelength λj. Thus, the component λj is added to the DWDM signal for a resultant DWDM signal at the output end 216 comprising the wavelengths λ1, λ2, λ3 . . . λh, λj. Consequently, the add/drop apparatus 200 has the advantage that the optical pathways are bi-directional to allow signal components to be added to a DWDM signal.

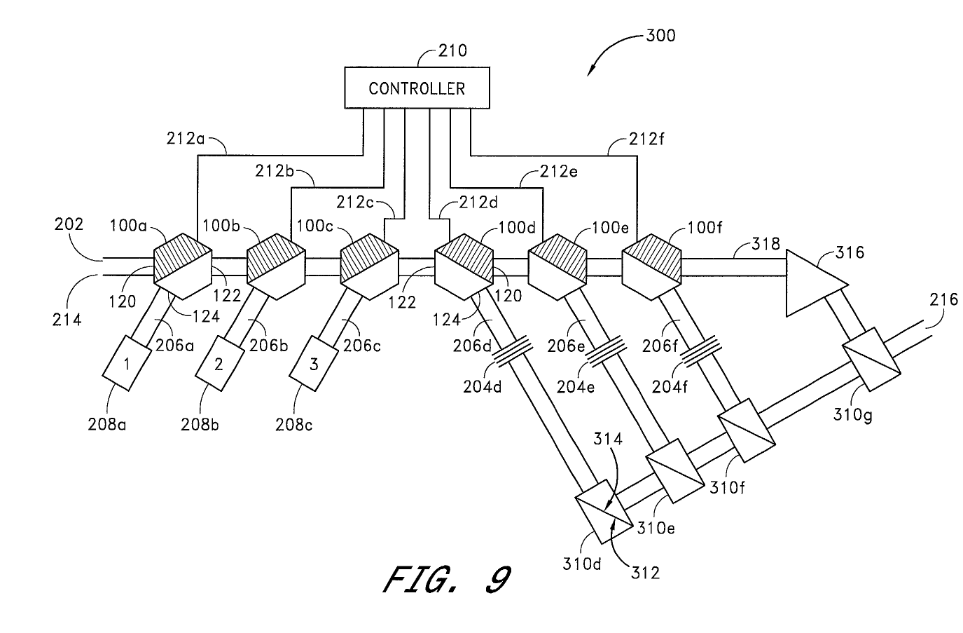

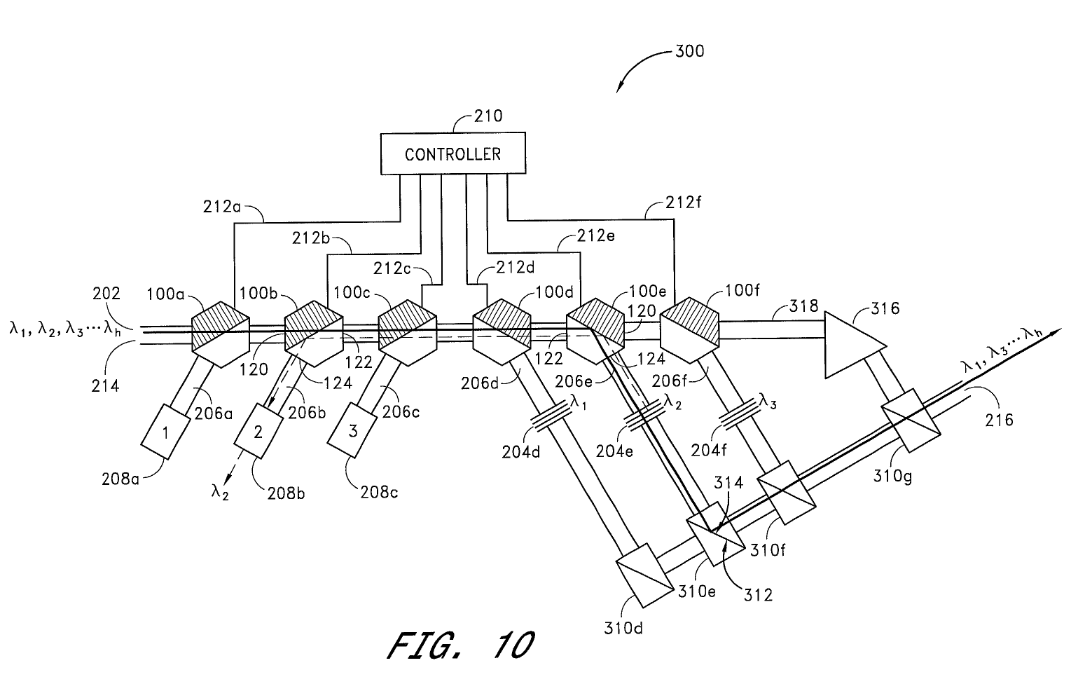

FIG. 9 shows a second embodiment of an add/drop apparatus 300, where a first set of optical switches 100a, 100b, 100c and a second set of optical switches 100d, 100e, 100f are positioned along the optical propagation path 202. Similarly to the first embodiment 200, each of the first set of optical switches 100a, 100b, 100c in the second embodiment 300 are oriented so that the respective first port 120 of the optical switch 100 faces the input end 214 of the optical propagation path 202. Thus, the first set of switches 100a, 100b, 100c are oriented so that a signal propagating from the input end 214 into the first set of switches 100a, 100b, 100c first enters the first portion 102 of each switch. Additionally, the input/output ports 208a, 208b, 208c are optically coupled to the optical switches 100a, 100b, 100c at the respective third port 124 of each optical switch 100.

In contrast, each of the second set of optical switches 100d, 100e, 100f are oriented so that the respective second port 122 faces the input end 214 of the optical propagation path 202. Thus, the second set of switches 100d, 100e, 100f are oriented so that a signal propagating from the input end 214 into the second set of switches 100d, 100e, 100f first enters the respective second portion 104.

Optical filters 204d, 204e, 204f are positioned between each of the respective second set of optical switches 100d, 100e, 100f and respective passive reflectors 310d, 310e, 310f along respective input/output paths 206d, 206e, 206f. Each optical filter path 206d, 206e, 206f is coupled to the respective second set of optical switches 100d, 100e, 100f at the respective third ports 124. The passive reflectors 310d, 310e, 310f are positioned to reflect a signal traveling from the respective optical filter 204d, 204e, or 204f toward the output end 216.

A further optical propagation path 318 extends from the third port 120 of the optical switch 100f to the output end 216 so that a signal that is not reflected by any of the optical switches 100d, 100e or 100f will propagate toward the output 216. As shown in FIG. 9, a reflector 316 is preferably positioned along the optical propagation path for directing a signal propagating from the optical switch 100f toward the passive reflector 310g. The passive reflector 310g is positioned so that a signal propagating from the reflector 316 is reflected toward the output end 216.

A controller 210 is electronically coupled to each of the optical switches 100a, 100b, 100c, 100d, 100e, 100f by signal lines 212a, 212b, 212c, 212d, 212e, 212f. The signal lines 212a, 212b, 212c, 212d, 212e, 212f are coupled to the electrodes 106a, 106b of each of the respective optical switches 100a, 100b, 100c, 100d, 100e, 100f.

Similarly to the first embodiment 200, the optical propagation paths 202 and 318 as well as the input/output paths 206a, 206b, 206c, 206d, 206e, 206f of the second embodiment 300 preferably comprise waveguides, as known by those skilled in the art. Alternatively, the above-described paths may comprise fiber tubing or other light propagating material known by those skilled in the art. As described above, these paths may also be through free space regions.

The add/drop apparatus 300 may select one wavelength out of a plurality of wavelengths to drop from an inputted signal. The apparatus 300 preferably utilizes a controller 210 to select one optical switch 100 out of the first set of optical switches 100a, 100b, 100c that corresponds to a desired input/output port 208a, 208b or 208c for sending a dropped wavelength. The controller 210 also selects one optical switch 100 of the second set of optical switches 100d, 100e, 100f that corresponds to an optical filter 204d, 204e or 204f that reflects a particular wavelength component. Thus, the controller 210 may drop a desired wavelength component by causing an inputted signal to pass through the corresponding optical filter 204d, 204e, or 204f.

Furthermore, if it is desired to not have any wavelength component dropped, the controller may not select any of the optical switches 100d, 100e or 100f. The inputted signal would then propagate through the optical switches 100d, 100e and 100f without reflection and through optical propagation path 314 to the output end 216. Thus, in this manner, the inputted signal would not pass through any of the optical filters 204d, 204e or 204f.

The above-described add/drop apparatus is merely one architecture of the second embodiment 300. For example, additional optical switches 100 coupled with input/output ports 208 or optical switches 100 coupled to optical filters 204 may be inserted along the optical propagation path 202. Furthermore, a plurality of add/drop apparatuses 300 can be cascaded to drop a plurality of wavelengths from an optical signal.

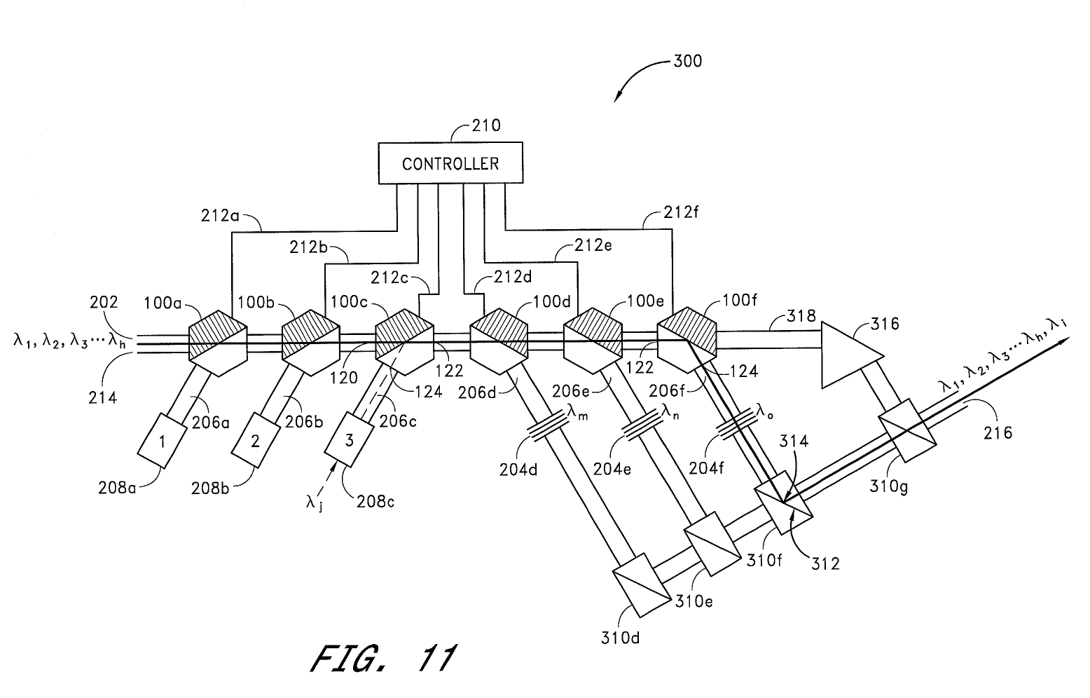

By way of example, the operation of the drop function of the second embodiment 300 is illustrated in FIG. 10. A DWDM signal (illustrated as a bold line) is applied at an input end 214 of the optical propagation path 202. The DWDM signal at the input end 214 comprises the wavelengths λ1, λ2, λ3 . . . λh.

The controller 210 preferably selects one optical switch (e.g., the switch 100b in FIG. 10) out of the first set of optical switches 100a, 100b, 100c to be in the on state, and sets the intervening optical switches (e.g., the switch 100c) to be in the off state. The intervening optical switches (e.g. switch 100c) are the switches among the first set 100a, 100b, 100c that are along the optical propagation path 202 between the selected switch (e.g. switch 100b), which is in the on state, and the second set of switches 100d, 100e, 100f. The optical switch 100a, 100b, or 100c to be in the on state is selected depending upon which respective input/output port 208a, 208b, or 208c is to receive a signal.

Similarly, the controller 210 preferably selects one optical switch (e.g., the switch 100e in FIG. 10) out of the second set of optical switches 100d, 100e, 100f to be in the on state, and sets the intervening optical switches (e.g., switch 100d) in the second set of optical switches 100d, 100e, 100f to be in the off state. The intervening optical switches (e.g. switch 100d) are the switches among the second set 100d, 100e, 100f that are along the optical propagation path 202 between the selected switch (e.g. switch 100e), which is in the on state, and the first set of switches 100a, 100b, 100c. The optical switch 100d, 100e, or 100f to be in the on state is selected depending upon which respective optical filter 204d, 204e or 204f is to receive a signal.

From the input end 214, the DWDM signal propagates along the optical propagation path 202 and enters the first set of optical switches 100a, 100b, 100c. The DWDM signal first passes through the first port 120 of the first optical switch 100a and into the first portion 102. The DWDM signal then crosses the boundary 108 into the second portion 104 and out of the optical switch 100a at the second port 120. As described above, the DWDM signal traveling from the first portion 102 to the second portion 104 does not experience TIR, whether or not the optical switch 100 is in the on state. Thus, the DWDM signal then propagates along the optical propagation path 202 through the rest of the first set of optical switches 100b, 100c in a similar manner.

The DWDM signal then enters the second set of optical switches 100d, 100e, 100f. Here, the DWDM signal first passes through the second port 122 of the fourth optical switch 100d and into the second portion 102. The DWDM signal then crosses the boundary 108 into the first portion 104 and out of the fourth optical switch 100d at the first port 120. As described above, the DWDM signal traveling from the second portion 104 to the first portion 102 only experiences TIR when the optical switch 100 is in the on state. Thus, since the controller 210 selected the fourth optical switch 100d to be in the off state, the DWDM signal is transmitted through the fourth optical switch 100d without reflection.

The DWDM signal then enters the fifth optical switch 100e, which is in the on state. Consequently, the DWDM signal enters the fifth optical switch 100e at the second port 122, propagates through the second portion 104 and is reflected at the boundary 108 toward the third port 124 and thus toward the input/output path 206e to the optical filter 204e. The DWDM signal exits the fifth optical switch 100e at the third port 124 and propagates down the input/output path 206e. The DWDM signal then passes through the respective optical filter 204e, wherein one component (e.g., the component at the wavelength λ2) is reflected. The selected component at the wavelength λ2 is referred to herein as the “component λ2.”

The DWDM signal (without the component λ2) then propagates toward the respective passive reflector (e.g., the passive reflector 310e). The passive reflectors 310 operate to transmit an optical signal without reflection that first strikes a first side 312 of a reflective boundary in the passive reflector, but reflects the optical signal when the optical signal first strikes a second side 314 in of the reflective boundary of the passive reflector 310e. The passive reflectors, for example, may comprise two portions, each having different refractive index that meet to form the reflective boundary. Light traveling from the portion with a high refractive index into the portion with a lower refractive index is reflected at the reflective boundary. Light traveling from the portion with the low refractive index into the portion with the high refractive index is transmitted.

Since the DWDM signal first strikes the second side 314 of reflective boundary of the passive reflector 310e, the DWDM signal is reflected by the passive reflector 310e toward the passive reflector 310f. The DWDM signal is then transmitted through the third passive reflector 310f without reflection because the DWDM signal first strikes the first side 312 of the reflective boundary in the passive reflector 310f. The DWDM signal is also similarly transmitted through the passive reflector 310g. Thus, the DWDM signal then propagates through the output end 216, where the resultant output DWDM signal is λ1, λ3 . . . λh.

The reflected component λ2 is depicted in FIG. 10 as the dashed arrow. The optical filter 206e reflects the component λ2 in a substantially opposite direction as the DWDM signal. Thus, the reflected component λ2 propagates back through the optical switch 100e.

As discussed above, the fifth optical switch 100e is in the on state, which causes the component λ2 to be reflected at the boundary 108 toward the first set of optical switches 100a, 100b, 100c. The component λ2 then passes through the fourth optical switch 100d without reflection. The component λ2 then enters the first set of switches 100a, 100b, 100c.

In FIG. 10, only the second switch 100b of the first set of switches 100a, 100b, 100c is in the on state. Thus, the component λ2 passes through the third optical switch 100c without reflection. The component λ2 then enters the second optical switch 100b, wherein the component λ2 is reflected at the boundary 108 of the second optical switch 100b to the third port 124, through the input/output path 206b, and into the input/output port 208b.

The second embodiment of the add/drop apparatus 300 may also use the input/output ports 208a, 208b, 208c for adding a wavelength component to a DWDM signal. By way of example, FIG. 11 shows a wavelength component λj added to the DWDM signal comprising the wavelengths λ1, λ2, λ3 . . . λh. Here, the DWDM signal is inserted at the input end 214, and the component λj is inserted through the input/output port 208c. The component λj propagates out of the input/output port 208c through the input/output path 206c and enters the third optical switch 100c.

In order to add the component λj to the DWDM signal, the controller 210 of the present embodiment 300 selects the third optical switch 100c to be in the on state. Consequently, the component λj enters the third optical switch 100c and is reflected at the respective boundary 108 in the direction of the second set of optical switches 100d, 100e, 100f. Thus, at this point, the component λj is added to the inputted DWDM signal, which is traveling along the optical propagation path 202. Consequently, the DWDM signal of FIG. 11 now comprises the wavelengths λ1, λ2, λ3 . . . λh, λj.

Preferably, the controller 210 selects one optical switch (e.g., the sixth optical switch 100f) in the second set of optical switches 100d, 100e, 100f to be in the on state, depending upon which optical filter (e.g., the optical filter 204f) is to receive the DWDM signal. Preferably, the controller 210 does not select an optical filter 204d, 204e or 204f tuned to the same wavelength as the added component, because this would drop the added component from the DWDM signal.

Alternatively, the controller 210 may select none of the optical switches in the second set of optical switches 100d, 100e and 100f to be in the on state so that the DWDM signal does not pass through any of the optical filters 204d, 204e and 204f . Instead, the DWDM signal passes through each of the optical switches 100d, 100e and 100f without reflection, into the optical propagation path 318 and to the output end 216.

In FIG. 11, the controller 210 selects the optical switch 100f to be in the on state. Thus, the DWDM signal is then reflected at the boundary 108 of the sixth optical switch 100f and propagates to the optical filter 204f. If the optical filter 204f is tuned to a wavelength component present in the DWDM signal, then that wavelength component is reflected back toward the sixth optical switch 100f and the rest of the DWDM signal propagates toward the respective passive reflector (e.g., the passive reflector 310f). Here, the optical filter 204f is tuned to the wavelength λo, and since the wavelength λo is not present in the DWDM signal, the optical filter 204f does not reflect any wavelength component of the DWDM signal.

After passing through the optical filter 204f, the DWDM signal is then incident on the second side 314 of the reflective boundary in the passive reflector 310f, and therefore is reflected by the passive reflector 310f to the output end 216. Thus, the resultant DWDM signal at the output end 216 is the inputted DWDM signal λ1, λ2, λ3 . . . λh, plus the added wavelength λj, minus any reflected wavelength λo. Consequently, the apparatus 300 has the advantage that signal components can be added to the multiplexed signal. The second embodiment 300 has that advantage of being able to select a plurality of input/output ports 208 and optical filters 204 to receive an optical signal.

The preferred embodiments described above have many advantages over the prior art. The prior art requires that an input signal be de-multiplexed before a component of the signal is dropped or added. The signal must then be multiplexed before it is sent out as an output signal. On the other hand, the preferred embodiments described above maintain a multiplexed beam throughout the system, thus eliminating the de-multiplexing and multiplexing steps. By eliminating the additional steps, the add/dropper of the present invention requires fewer components. Fewer components translate into a device that is smaller and less expensive than the prior art devices.

Although described above in connection with particular embodiments of the present invention, it should be understood the descriptions of the embodiments are illustrative of the invention and are not intended to be limiting. For example, other types of optical switches, some well known, others yet to be devised, may be suitably employed to switch the optical signals. For instance, other devices that switch light by creating a total internal reflection boundary may be utilized. Bubble switches which rely on liquid or vapor ejected from jets to create a total reflection boundary may substitute for the PLZT-based TIR switches described above. Alternatively, other switchable reflectors such as mirrors mounted on movable micro-mechanical devices, conventionally referred to as MEMs, may provide another option. Accordingly, various modifications and applications may occur to those skilled in the art without departing from the true spirit and scope of the invention as defined in the appended claims.

What is claimed is:

1. An apparatus for selectively outputting at least one optical signal at a selected wavelength from a plurality of optical signals at a plurality of wavelengths, comprising:
an optical propagation path in which optical signals propagate in a first direction and a second direction;
at least one wavelength selective reflector positioned at a location in the optical propagation path and tuned to at least one optical wavelength;
at least one optical switch in said optical propagation path, said at least one switch having a first port, a second port and a third port, the optical switch selectively operating in one of a first state and a second state, the optical switch passing optical signals propagating in the first direction from the first port to the second port when the optical switch is operating in either the first state or the second state, the optical switch passing at least one optical signal propagating in the second direction from the second port to the first port when the optical switch is operating in the first state, the optical switch reflecting the at least one optical signal propagating in the second direction from the second port to the third port when the optical switch is operating in the second state; and
an output propagation path coupled to the third port of the optical switch to receive the at least one optical signal when the optical switch is operating in the second state.

2. The apparatus of claim 1, further comprising an optical waveguide comprising at least a portion of said optical propagation path.

3. The apparatus of claim 1, wherein said at least one optical switch comprises an electro-optic switch.

4. The apparatus of claim 1, wherein said at least one optical switch comprises a reflecting switch.

5. The apparatus of claim 4, wherein said at least one optical switch comprises a total internal reflection switch.

6. The apparatus of claim 1, wherein said at least one wavelength selective filter comprises grating.

7. The apparatus of claim 6, wherein grating is selected from the group consisting of a fiber grating and a waveguide grating.

8. The apparatus of claim 1, comprising a plurality of optical switches in said optical propagation path.

9. The apparatus of claim 8, wherein said plurality of optical switches are connected along said first optical propagation path by waveguides.

10. The apparatus of claim 1, further comprising at least one counter-opposing optical switch in said optical propagation path, said at least one counter-opposing switch having a first port, a second port and a third port, the optical switch selectively operating in one of a first state and a second state, the optical switch passing optical signals propagating in the second direction from the first port to the second port when the optical switch is operating in either the first state or the second state, the optical switch passing at least one optical signal propagating in the first direction from the second port to the first port when the optical switch is operating in the first state, the optical switch reflecting the at least one optical signal propagating in the first direction from the second port to the third port when the optical switch is operating in the second state, wherein said at least one of said wavelength selective reflector includes a wavelength selective filter situated to receive light propagating through said third port of said at least one counter-opposing optical switch.

11. The apparatus of claim 10, wherein said at least one optical switch comprises a plurality of optical switches, said at least one counter-opposing optical switches comprises a plurality of counter-opposing optical switches, and said at least one wavelength selective filter comprises a plurality of wavelength selective filters, each of said counter-opposing optical switches being associated with one of said wavelength selective filters.

12. An apparatus for selectively outputting at least one optical signal at a selected wavelength, the at least one optical signal propagating with a plurality of optical signals at a plurality of wavelengths, the apparatus comprising:
an optical path for propagating the plurality of optical signals, the optical path having a first propagation direction and a second propagation direction;
at least one optical switch positioned at a first location in the optical path, the optical switch switchable between a first state and a second state, the optical switch operating in the first state to propagate optical signals propagating in the first direction and optical signals propagating in the second direction without reflection, the optical switch operating in the second state to propagate optical signals propagating in the first direction without reflection and to reflect optical signals propagating in the second direction; and
at least one wavelength selective reflector positioned at a second location in the optical path, the second location disposed in the first direction from the first location, the wavelength selective reflector operating to reflect an optical signal at a selected wavelength propagating in the first direction from the optical switch to cause the optical signal at the selected wavelength to propagate in the second direction toward the optical switch and to be reflected by the optical switch when the optical switch is operating in the second state; and
an output port coupled to the optical switch to receive the optical signal reflected by the optical switch, thereby separating the optical signal at the selected wavelength from the plurality of optical signals.

13. The apparatus of claim 12, further comprising:
at least one optical switch positioned at a third location in the optical path between the first and second location, the optical switch switchable between a first state and a second state, the optical switch operating in the first state to propagate optical signals propagating in the first direction and optical signals propagating in the second direction without reflection, the optical switch operating in the second state to propagate optical signals propagating in the second direction without reflection and to reflect optical signals propagating in the first direction,
wherein said at least one optical switch directs said plurality of optical signals propagating in the first direction to said at least one wavelength selective reflector when the optical switch is operating in the second state.

14. The apparatus of claim 1, wherein said at least one of optical switches at said first and third locations comprises a total internal reflection switch.

15. The apparatus of claim 14, wherein said total internal reflection switches comprise electro-optic material.

16. The apparatus of claim 15, wherein said electro-optic material comprises PLZT.

17. The apparatus of claim 14, wherein said at least one wavelength selective reflector comprises a Bragg grating.

18. The apparatus of claim 13, wherein said at least one optical switch at said first location comprises a plurality of optical switches.

19. The apparatus of claim 18, wherein said at least one optical switch at said third location comprises a plurality of optical switches.

20. The apparatus of claim 19, wherein at least a portion of said optical path is comprises a waveguide.

21. A method of selectively separating a wavelength component from a wavelength division multiplexed optical signal, comprising:
receiving a wavelength division multiplexed optical signal;
propagating the wavelength division multiplexed signal through at least one switch in a first direction toward a wavelength selective filter;
selecting a component of the wavelength division multiplexed signal at a selected wavelength from the wavelength selective filter and propagating said component in a second direction toward the switch; and
selecting a port for receiving said component of the wavelength division multiplexed signal by setting the switch to a state to complete an optical path from said wavelength selective filter to said port.

22. The method of claim 21, wherein said step of selecting said component of the wavelength division multiplexed optical signal comprises switching between one of a plurality of wavelength selective filters to receive said wavelength multiplexed optical signal.

23. The method of claim 22, wherein said step of switching between one of a plurality of wavelength selective filters comprises propagating the wavelength division multiplexed signal through at least one switch in a first direction toward a wavelength selective filter.

24. The method of claim 21, wherein said step of selecting a component comprises reflecting a selected wavelength of the wavelength division multiplexed signal from a wavelength selective reflector in a second direction toward the switch.

25. The method of claim 24, wherein the step of selecting a port comprises reflecting the component of the wavelength division multiplexed signal off a reflective surface of the switch to said port.

26. The method of claim 21, further comprising the step of adding a component at a selected wavelength to the wavelength division multiplexed signal.

27. The method of claim 21, wherein said wavelength selective filter comprises a Bragg grating.
